(19) United States
(12) Patent Application Publication
(10) Pub. No.: US 2014/0373061 A1
(43) Pub. Date: Dec. 18, 2014

(54) Method, Device, and Computer Program Product

(71) Applicants: Kabushiki Kaisha Toshiba, Tokyo (JP); Toshiba Lifestyle Products & Services Corporation, Tokyo (JP)

(72) Inventors: Munehiro Tokikura, Kawasaki Kanagawa (JP); Chikara Ushimaru, Akishima (JP); Mikiko Karasawa, Musashino (JP)

(21) Appl. No.: 14/470,764

(22) Filed: Aug. 27, 2014

Related U.S. Application Data
(63) Continuation of application No. PCT/JP2013/062281, filed on Apr. 25, 2013.

(51) Int. Cl. H04N 21/482; H04N 21/431; H04N 21/472

(52) U.S. Cl. CPC H04N 21/482; H04N 21/47214; H04N 21/431
USPC 725/40

(57) ABSTRACT

According to one embodiment, a program listing display method includes: obtaining data of a first program and data of a second program through a communication network; obtaining, though the communication network, first reservation information of the first program and second reservation information of the second program in an electronic device; and outputting data of a program listing containing the data of the first program, the data of the second program, the first reservation information, and the second reservation information. In the data of the program listing, in accordance with newness of the first reservation information or the second reservation information, a display mode of the data of the first program differs from a display mode of the data of the second program, or a display mode of the first reservation information differs from a display mode of the second reservation information.

### CROSS-REFERENCE TO RELATED APPLICATIONS

This application is a continuation of international application No. PCT/JP2013/062281, filed Apr. 25, 2013, which designates the United States, the entire contents of which are incorporated herein by reference.

### FIELD

Embodiments of the present invention relate to a method, a device, and a computer program product.

### BACKGROUND

Conventionally, there has been known a device that display a program listing based on data obtained through a communication network.

In this type of device, reservation information that indicates the status of reservation of watching and video recording in an electronic device is displayed together with a program listing. The reservation information is updated as needed, for example, by operation of a user. The reservation information displayed on the device is preferably correct information.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary explanatory view illustrating a schematic configuration of one example of a system that includes a program listing display device in an embodiment;

FIG. 2 is an exemplary block diagram illustrating one example of a program listing display device in the embodiment;

FIG. 3 is an exemplary flowchart illustrating one example of communication processing and processing that acquires data on reservation information in a program listing display device in the embodiment;

FIG. 4 is an exemplary flow chart illustrating one example of display processing of a program listing in a program listing display device in the embodiment.

FIG. 5 is an exemplary diagram illustrating one example of a program listing containing reservation information displayed on a program listing display device in the embodiment;

FIG. 6 is an exemplary diagram illustrating another example of a program listing containing reservation information displayed on a program listing display device in the embodiment; and

FIG. 7 is an exemplary diagram illustrating one example of a program listing containing program-related information displayed on a program listing display device according to a modification.

### DETAILED DESCRIPTION

In general, according to one embodiment, a method comprises: obtaining data of a first program and data of a second program through a communication network; obtaining, though a communication network, first reservation information of the first program and second reservation information of the second program in an electronic device; and outputting data of a program listing containing the data of the first program, the data of the second program, the first reservation information, and the second reservation information for displaying. In the data of the program listing, if a period elapsed since a timing of obtaining the first reservation information is different from a period of elapsed since a timing of obtaining the second reservation information, a display mode of the data of the first program differs from a display mode of the data of the second program, or a display mode of the first reservation information differs from a display mode of the second reservation information.

### Embodiment

The following embodiment and modification include similar constituent elements. These similar constituent elements are identified with the same reference numerals, and an overlapped description is omitted. In embodiments and modifications that include similar constituent elements, the same results (effect) based on the similar constituent elements can be obtained. In the specification, ordinal numbers such as first and second is used for distinguishing constituent elements and the like for convenience sake and do not mean the order, priority, degree of importance, etc., of processing.

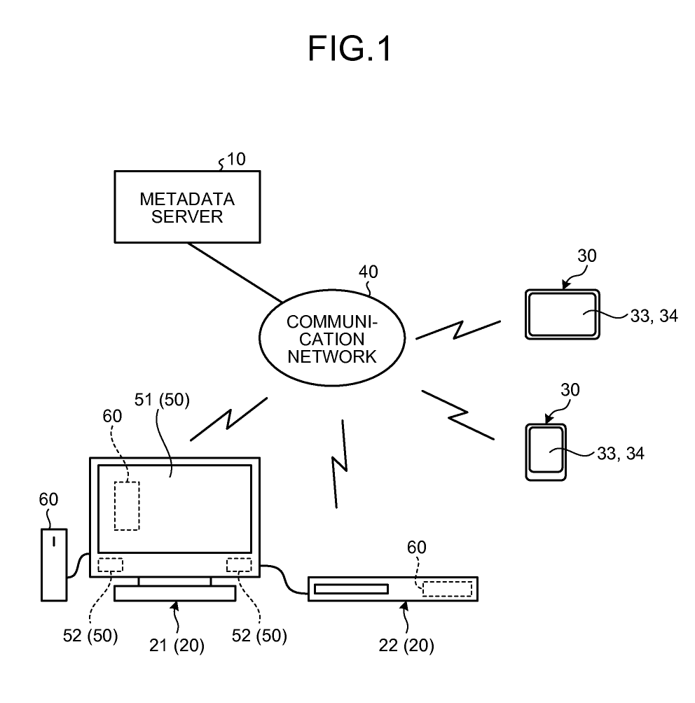

In this embodiment, as illustrated in FIG. 1, a system includes, for example, a metadata server 10 (server), an electronic device 20, a program listing display device 30 (device) and the like. The metadata server 10, the electronic device 20, and the program listing display device 30 are electrically connected through a wire or wireless communication network 40 (electric communication line). The communication network 40 includes, for example, instruments such as a router, a base station device, and an access point, a cable and the like (not shown). Various data are provided or received (communicated) between the metadata server 10, the electronic device 20, and the program listing display device 30 through the communication network 40 according to a predetermined communication protocol.

The electronic device 20 (reservation execution device) can receive broadcast waves containing data on contents (programs and the like) (loaded with the data). The electronic device 20 can control an output device 50 or transmit video data (image data) or audio data to the output device 50. The output device 50 can output video and voices of contents. The electronic device 20 includes, for example, a television receiver 21, a recorder 22, a home terminal (not illustrated), a personal computer (not illustrated) and the like. The output device 50 includes a display output device 51 (a display output module, for example, a display panel), a voice output device 52 (a voice output module, for example, a speaker) and the like. The output device 50 may be integrated with the electronic device 20 or alternatively may be separated from the electronic device 20.

The electronic device 20 has a reservation function of program watching and recording. Data on reservation information of watching and recording in the electronic device 20 is stored in a storage module 60. The reservation information is information about reservation of program, information indicating the mode of reservation of program, or information related to program, and examples thereof include program identification ID, program channel, broadcasting date and time, and reservation type. The storage module 60 is a nonvolatile storage module, and HDDs (hard disk drives) and SSDs (solid state drives) maybe mentioned as an example of the nonvolatile storage unit. The storage module 60 may be included in the electronic device 20 or alternatively may be a device separated from the electronic device 20. The electronic device 20 is operated according to the reservation information. Specifically, the electronic device 20 controls the output device 50 or transmits data on video and voices to the output device 50 according to watching reservation (watching reservation information or information indicating reservation of watching). In the output device 50, video and voices are output according to reservation information of watching reservation. The electronic device 20 stores content data on the storage module 60 in response to recording reservation (reservation information about recording or information indicating recording reservation). Data on the reservation information (data corresponding to reservation information) may be stored on a storage module that is different from a storage module on which content data (data corresponding to contents) are stored. The reservation information is an example of program-related information (meta information or attribute information).

Further, the electronic device 20 can transmit reservation information (data thereof) to the program listing display device 30 in response to a request from the program listing display device 30 (receipt of data (first data) for the transmission of data on reservation information).

The program listing display device 30 receives data that are a source of the program listing (data that are a source of program data and list) through the communication network 40. Data that are the source of the program listing include, for example, channel list data and program information data (data corresponding to program information). These data are acquired from the metadata server 10 through the communication network 40. The program listing display device 30 can control a display device 34 so as to display a program listing and to transmit data on the program listing (display data) to the display device 34. The display device 34 displays the program listing. Examples of the display device 34 include personal computers (for example, tablet computers), smartphones, cellular phones, PDAs (personal digital assistants), and game machines. In FIG. 1, the program listing display device 30 is exemplified as tablet computers. The program listing display device 30 is an example of handheld terminals, communication devices, and remote devices.

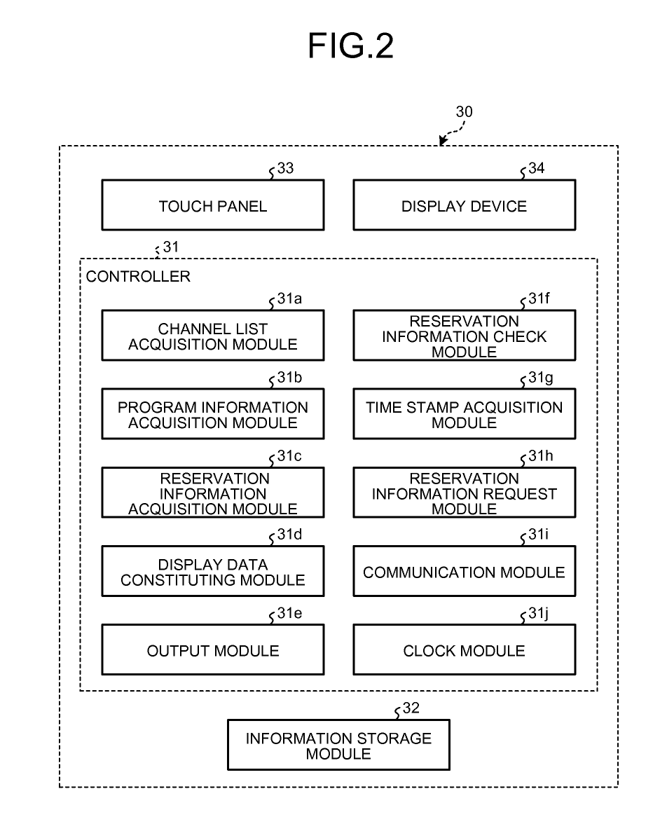

The program listing display device 30 is configured as a computer and comprises a CPU (a central processing unit), a controller, a storage module, an input module, an output module, an interface, and/or the like. Examples of the storage module include RAMs (random access memories), ROMs (read only memories), HDDs, and SSDs. The storage module includes an information storage module 32. The information storage module 32 stores data as a source of the acquired program listing, data on reservation information (related information), time stamps of data on the reservation information and the like. The information storage module 32 is a nonvolatile storage module, and examples thereof include HDDs and SDDs. Examples of the input module include a touch panel 33 and a keyboard (not shown). Examples of the output module include the display device 34 and a speaker (not illustrated). Examples of the display device 34 include LCDs (liquid crystal displays) and OELDs (organic electro-luminescent displays). The CPU can execute various arithmetic processings according to loaded programs (for example, OS (operating system), applications, and web applications). In this embodiment, for example, processing of CPU according to the program allows a controller 31 (a channel list acquisition module 31a, a program information acquisition module 31b, a reservation information acquisition module 31c, a display data constituting module 31d, an output module 31e, a reservation information check module 31f, a time stamp acquisition module 31g, a reservation information request module 31h, a communication module 31i, and a clock module 31j) illustrated in FIG. 2 to function.

The program can be recorded as an installable or executable file on recording media that is readable with a computer, such as CD-ROMs (compact disk ROMs), FDs (flexible disks), CD-Rs (CD recordable), and DVDs (digital versatile disks) to be provided. The program can be stored on a storage module in a computer connected to a communication network and can be introduced by downloading through a network. Alternatively, the program may be previously incorporated for example, in ROMs.

For example, the channel list acquisition module 31a obtains a channel list (data thereof) from the metadata server 10. The channel list includes, for example, names of broadcasting stations and channel numbers. The program information acquisition module 31b obtains program information (data thereof) from the metadata server 10. The program information includes, for example, program IDs, program titles, program numbers, broadcasting dates and times of programs, explanation of programs, channel names, channel logos, and broadcasting station names. Data on acquired channel lists and program information and the like (data on programs) are stored on the information storage module 32. In this embodiment, the channel list acquisition module 31a or the program information acquisition module 31b may be mentioned as an example of a first acquisition module.

The reservation information acquisition module 31c (related information acquisition module) obtains reservation information (data thereof) in the electronic device 20. The acquired data of reservation information is stored on the information storage module 32 (storage module). In this embodiment, the reservation information acquisition module 31c may be mentioned as an example of a second acquisition module. The reservation information acquisition module 31c may acquire data on reservation information from the electronic device 20 or alternatively may acquire the data from another device (for example, a server (not illustrated)). In this case, every time when the status of reservation (reservation information) in the electronic device 20 is updated, the electronic device 20 transmits updated (latest) reservation information (data thereof) to another device. The another device stores data on the reservation information on an information storage module (not illustrated) in the another device.

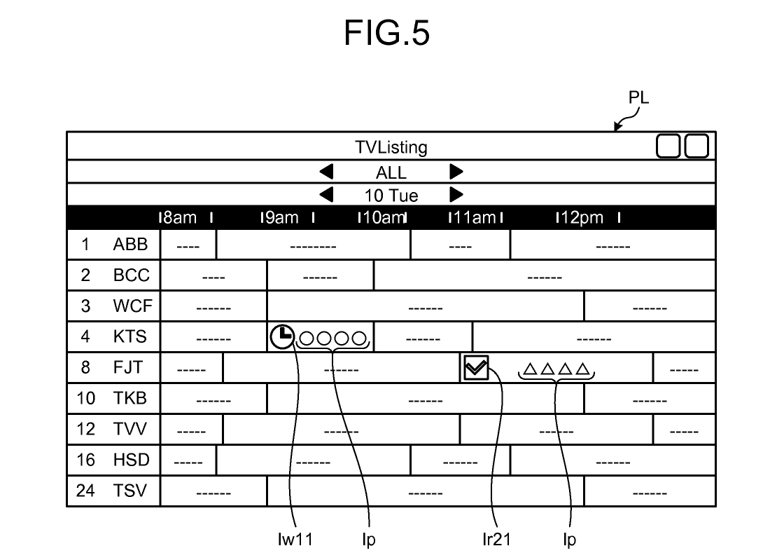

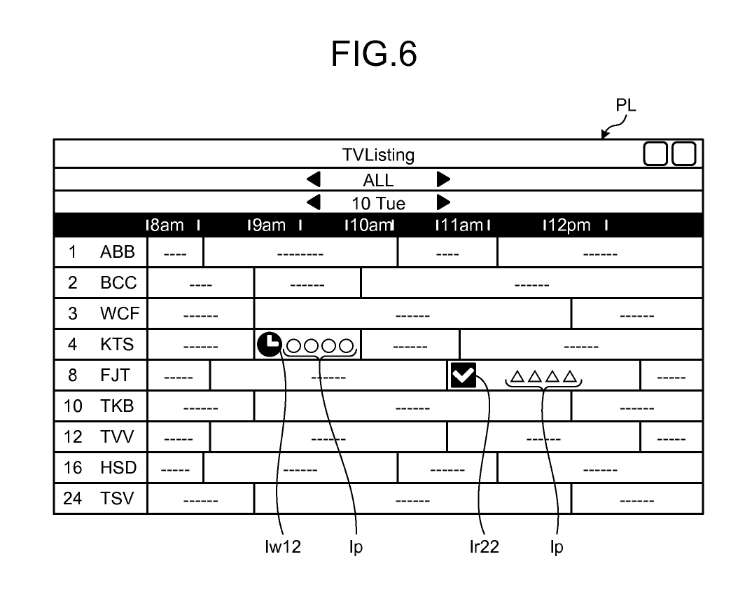

For example, the display data constituting module 31d constitutes data on a program listing displayed on the display device 34 (display data), for example, from the acquired channel list, program information, and reservation information (related information). The output module 31e (for example, display controller and display data transmitter) transmits constituted program listing data (display data) to the display device 34. The display device 34 displays a program listing PL (see FIGS. 5 and 6) based on data on the program listing received from the output module 31e.

The reservation information check module 31f (related information check unit) checks newness of the reservation information (related information). For example, the reservation information check module 31f can check an elapsed time from a reference time that is a reference of newness of reservation information through the acquisition of data on a current time from the clock module 31j. The reference time may be, for example, a time (clock time) indicated on a time stamp corresponding to the reservation information. The time stamp may be, for example, data on time at which data on reservation information have been obtained in the program listing display device 30 (reservation information acquisition module 31c thereof) (time stamp provided at the time of reception), or data on time at which data on reservation information have been transmitted from a transmission source such as the electronic device 20 or other devices (or just before the transmission) (time stamp provided at the time of transmission). The time stamp (data) is stored on the information storage module 32 in association with data on reservation information. Data indicating time at which data on reservation information have been transmitted from the electronic device 20 are an example of data corresponding to newness of the reservation information.

The time stamp acquisition module 31g acquires a time stamp of reservation information. The time stamp acquisition module 31g can obtain a time stamp at the time of transmission, for example, from a device of a transmission source of data on reservation information (for example, the electronic device 20 or other devices). Alternatively, the time stamp acquisition module 31g can acquire (generate) a time stamp at the time of reception while referring to the clock module 31j, for example, when data on reservation information have been obtained in the program listing display device 30 (reservation information acquisition module 31c thereof). The time stamp acquisition module 31g is an example of a third acquisition module.

The reservation information request module 31h (related information request module) transmits data for the transmission of data on reservation information (related information) (data (command) that requests data on reservation information, first data), for example, to a device of a transmission source such as the electronic device 20 or a server. The reservation information request module 31h can repeatedly transmit data for the transmission of data on reservation information at predetermined time intervals.

The communication module 31i (communication establishment module and communication establishment trial module) can perform the provision or reception (communication) of predetermined data between the communication module 31i and a device of a transmission source of reservation information (data thereof) such as the electronic device 20 or a server. The communication module 31i can attempt to transmit data (response request, command) to a transmission source of data on reservation information at predetermined intervals and to establish communication. The communication module 31i can each time repeatedly attempt establishment of communication.

In this embodiment, the display data constituting module 31d can constitute data of a program listing PL in which a display mode thereof is made different in accordance with an elapsed time from a reference time. The output module 31e can output data of the program listing PL in which the display mode is made different in accordance with newness of reservation information (related information). In the program listing PL illustrated in FIGS. 5 and 6, for example, the lateral direction represents a time axis and is sectionalized into channel for each line, and each program is surrounded by a frame. In each frame, a display element Ip corresponding to program information that corresponds to the frame is displayed, for example, by letters or figures. FIG. 5 illustrates an example of a program listing PL when the reservation information is new (for example, the elapsed time from the reference time of the reservation information is shorter than a predetermined time), and FIG. 6 illustrates an example of a program listing PL when the reservation information is old (for example, the elapsed time from the reference time of the reservation information is equal to or greater than a predetermined time (threshold value)). In these examples, patterns Iw11 and Iw12 are an example of the display element of the first reservation information (data thereof) of the first program indicating that reservation for watching has been made for the first program. Further, patterns Ir21 and Ir22 are an example of the display element of the second reservation information (data thereof) of the second program indicating that reservation for program recording has been made for the second program. The patterns Iw11 and Ir21 illustrated in FIG. 5 are an example of a display element corresponding to reservation information that is newer than the patterns Iw12 and Ir22 illustrated in FIG. 6. In this embodiment, for example, the patterns Iw11 and Ir21 illustrated in FIG. 5 are different from the patterns Iw12 and Ir22 illustrated in FIG. 6 in color that is an example of the display mode. Specifically, in this embodiment, for example, the display mode of the display element illustrated in FIG. 5 (patterns Iw11 and Ir21) corresponding to new (newer than that in FIG. 6) reservation information is different from the display mode of the display element illustrated in FIG. 6 (patterns Iw12 and Ir22) corresponding to old (older than that in FIG. 5) reservation information. In FIGS. 5 and 6, the patterns Iw11, Ir21, Iw12, and Ir22 are distinguished by black and white colors. The color of the pattern Iw11 and the color of the pattern Ir21 in FIG. 5 are the same as each other, and the color of the pattern Iw12 and the color of the pattern Ir22 in FIG. 6 are the same as each other. For example, the patterns Iw11 and Ir21 corresponding to new reservation information may be colorless or colored with white, and the patterns Iw12 and Ir22 corresponding to old reservation information may be colored with red. Thus, in this embodiment, for example, the user can recognize whether the reservation information of the corresponding program recording or watching is new or old according to the display mode of the patterns Iw11, Ir21, Iw12, and Ir22. The examples illustrated in FIGS. 5 and 6 are merely an illustration, and the display mode can be further varied in a multistage or continuously according to the length of the elapsed time from the reference time of the reservation information. The display mode other than the color of the patterns Iw11, Ir21, Iw12, and Ir22 (for example, size, shape, and angle) maybe differentiated according to the newness of the reservation information, and the display mode of the program listing PL per se (for example, background color and color of line) may be differentiated. Further, data displayed within the frame of the first program (for example, color, background color, color of line of letters, figures, etc., of program information) may be different from data displayed within the frame of the second program. The program listing PL includes reservation information of a plurality of electronic devices 20. In this case, when newness of the reservation information corresponding to an electronic device 20 differs from newness of the reservation information corresponding to another electronic device 20, the display mode of the display element of the program information or the reservation information corresponding to the electronic devices 20 may be different between the electronic devices 20.

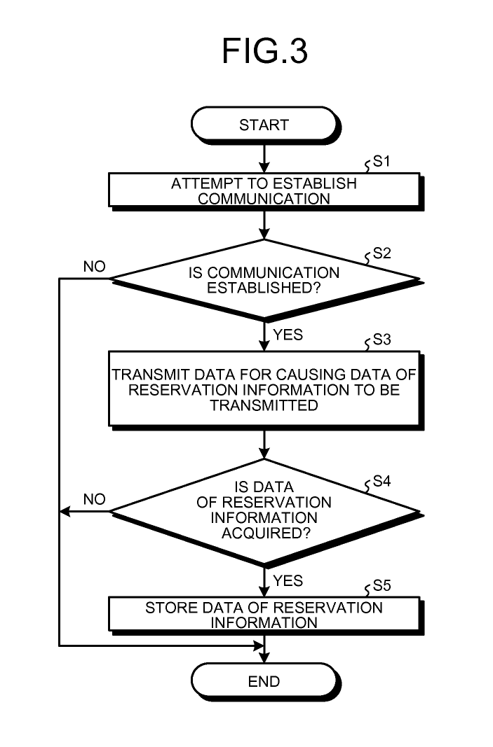

Here, with reference to FIG. 3, an example of a procedure of communication processing between the program listing display device 30 and a device of a transmission source of reservation information (related information) (for example, an electronic device 20 and other devices) and processing of acquiring reservation information(data thereof) will be described. First, the communication module 31i transmits data (response request, command) to a device which is a transmission source of data of reservation information, at predetermined time intervals (periodically), to make an attempt to establish communication with the device of the transmission source of the reservation information (S1). When the communication has been established (Yes in S2), the reservation information request module 31h repeatedly transmits data (first data) for the transmission of data on the latest reservation information to the device of the transmission source at predetermined time intervals (S3). When the reservation information acquisition module 31c could acquire data on the latest reservation information as a result of S3 (Yes in S4), the reservation information acquisition module 31c stores acquired reservation information (related information) and the like in an information storage module 32 (S5). When the result is No in S2 and, further, the result is No in S4, a series of processings illustrated in FIG. 3 is terminated.

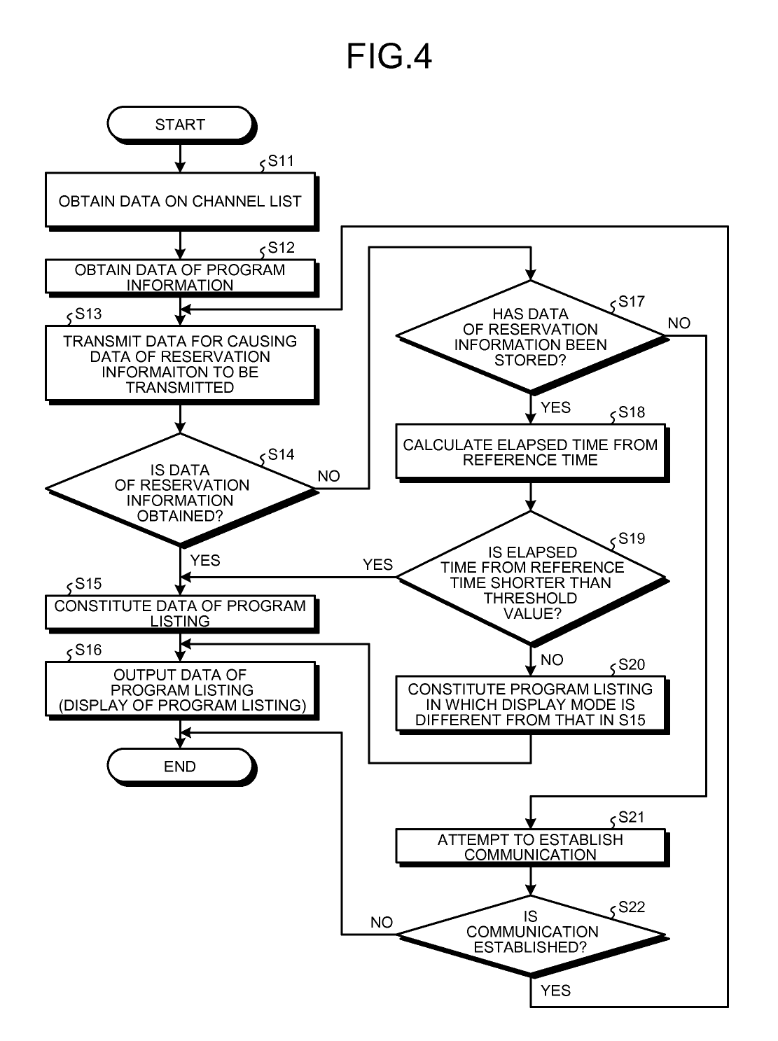

Next, with reference to FIG. 4, an example of a procedure of displaying the program listing PL (list) illustrated in FIGS. 5 and 6 on the display device 34 will be described. The channel list acquisition module 31a obtains data on a channel list (S11). The program information acquisition module 31b then obtains data on program information (S12). The reservation information request module 31h repeatedly transmits data (first data) for the transmission of data on the latest reservation information to the device of the transmission source at predetermined time intervals (S13). The repeated transmission of the data in S13 is terminated when data on the reservation information have been obtained or when a predetermined time (threshold value of time) in S13 has elapsed. When the reservation information acquisition module 31c could obtain data on reservation information as a result of S13 (Yes in S14), the display data constituting module 31d constitutes data on program listing displayed on the display device 34, for example, from the acquired channel list, program information, and reservation information (related information) (S15). The output module 31e transmits data on the constituted program listing to the display device 34 (S16). Thus, the display device 34 displays the program listing PL based on data on the program listing (see FIGS. 5 and 6).

When the reservation information acquisition module 31c could not obtain data on reservation information from the device of the transmission source as a result of S13 (No in S14) and, at the same time, when data on reservation information have been stored on the information storage module 32 (Yes in S17), the reservation information check module 31f checks data on reservation information stored on the information storage module 32 and calculates an elapsed time to the current time from the reference time that is a reference of newness of the reservation information (S18). In S18, when the elapsed time is shorter than the predetermined time in the S18, that is, when the elapsed time is not more than the threshold time (threshold value of time) (Yes in S19), data of the program listing displayed on the display device 34 is constituted, for example, from the reservation information of data on the reservation information stored in the information storage module 32, channel list acquired in S11, and program information acquired in S12 (S15). On the other hand, in S18, the elapsed time is equal to or more than the predetermined time in S18, that is, when the elapsed time is equal to or more than the threshold value (threshold value of time) (No in S19), the display data constituting module 31d constitutes data on a program listing displayed on the display device 34, for example, from the reservation information of data on reservation information stored in the information storage module 32, channel list acquired in S11 and program information acquired in S12. In this case, data on program listing PL that is different in display mode from that when the result in S19 is Yes are constituted (S20). The output module 31e transmits data on the constituted program listing to the display device 34 (S16). Thus, the display device 34 displays the program listing PL (see FIGS. 5 and 6) based on data on the program listing. When the result is No in S17, the communication module 31i repeatedly transmits data (response request, command) to a device of a transmission source of data on reservation information, and an attempt is made to establish communication with the transmission source of the reservation information (S21). When the communication is established within a predetermined time (threshold value of time) in S21 (Yes in S22), the step is transferred to S13. When the result is No in S22, a series of processings illustrated in FIG. 4 is terminated.

As described above, in an embodiment of the present invention, for example, in accordance with newness of the first reservation information or the second reservation information, a display mode of a display element corresponding to the data of the first program differs from a display mode of a display element corresponding to the data of the second program, or a display mode of the first reservation information differs from a display mode of the second reservation information. Thus, in an embodiment of the present invention, for example, a user can learn newness (oldness) of the reservation information from the display mode (difference or change therein) of the program listing PL. Thus, for example, the occurrence of an unfavorable phenomenon for users derived from display of old reservation information is likely to be suppressed.

According to this embodiment, for example, data (display data) of the program listing PL is output so that the display mode thereof is made different in accordance with newness of the reservation information (related information). In this case, between when the reservation information is new and when the reservation information is old, the display mode of the program listing PL may be wholly different (for example, different in background color), the display mode of the program listing PL may be partially different (for example, the color of a frame line in the program listing is different), the display mode of the display element of the program information contained in the program listing PL may be different, the display mode of the display element corresponding to the reservation information contained in the program listing PL may be different, or the display mode of the display element different from the program information and reservation information contained in the program listing PL maybe different. Thus, in an embodiment of the present invention, for example, users can recognize newness (oldness) of the reservation information from the display mode (difference or change therein) of the program listing PL. Thus, for example, the occurrence of an unfavorable phenomenon for users derived from display of old reservation information is likely to be suppressed.

In this embodiment, for example, newness of the reservation information (related information) is determined by the elapsed time from the reference time (for example, elapsed time from a time at which the reservation information has been obtained). Thus, in this embodiment, for example, newness (oldness) of the reservation information can more easily be determined (compared). Further, in this embodiment, for example, the reference time may be a point of time at which data on reservation information have been acquired in the reservation information acquisition module 31c. Thus, in an embodiment of the present invention, for example, the reference time and thus the elapsed time can more easily be obtained.

In this embodiment, for example, first data for the transmission of data on the reservation information are transmitted to a device of a transmission source of data on reservation information (related information) (for example, electronic device 20 or other devices). Thus, in an embodiment of the present invention, for example, data on new reservation information can easily be obtained.

In this embodiment, for example, when the elapsed time from the reference time of the reservation information (related information) is more than a predetermined time (threshold time), data (first data) for the transmission of data on the reservation information are transmitted to a device of a transmission source of data on the reservation information. Thus, in this embodiment, for example, data on new reservation information can more efficiently be obtained. In other words, wasteful data transmission can be suppressed.

In this embodiment, for example, when a response from the device of the transmission source has been obtained as a result of attempt to establish communication with the device of transmission source, data (first data) for the transmission of data on the reservation information are transmitted to the device, which is the transmission source of data of the reservation information (related information). Thus, in this embodiment, for example, data on new reservation information can more efficiently be obtained. In other words, wasteful data transmission is likely to be suppressed.

In this embodiment, for example, data on data (time amp) of the reference time (elapsed time=0) that is a reference of newness of the reservation information can be acquired through the communication network. Thus, in an embodiment of the present invention, for example, the elapsed time is calculated from data on the reference time of the reservation information obtained through the communication network.

### Modification

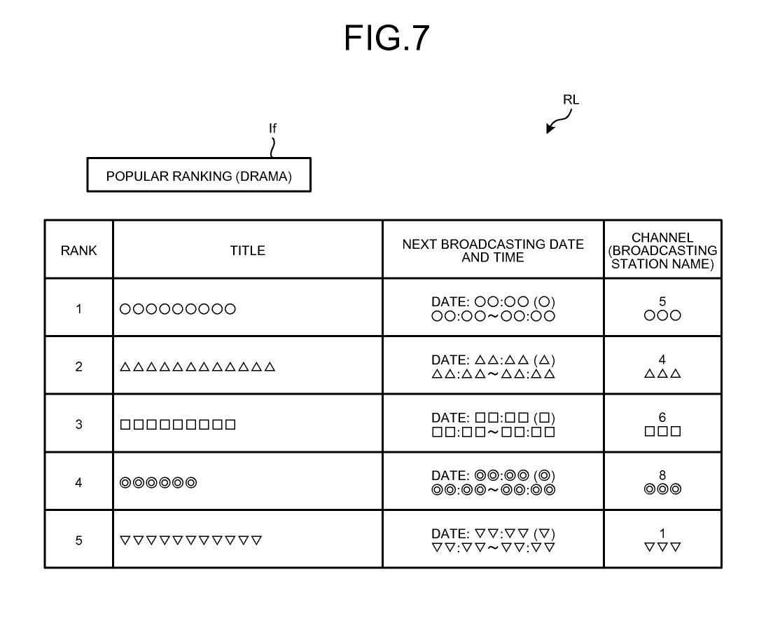

In this modification, as illustrated in FIG. 7, in the program listing display device 30, a program (content) ranking table RL is displayed instead of the program listing PL in the embodiment. In the ranking table RL, for each ranking, title of program, next broadcasting date and time, and channel (broadcasting station name) are indicated. In the modification, information indicating the ranking is an example of related information. The information indicating the ranking is acquired from the metadata server 10. For the ranking table RL, the pattern If indicating newness (oldness) of ranking information (related information) is indicated. In the modification, a display mode (for example, background color) of the pattern If (area, colored area) of the title of the ranking table RL can be varied according to the newness. For example, a method may be adopted in which, when the ranking information is new, the color of background of the pattern If is green, while, when the ranking information is old, the color of background of the pattern If is yellow. In this modification embodiment, for example, users can recognize newness (oldness) of information indicating ranking (related information) from the display mode of the ranking table RL. Thus, for example, the occurrence of an unfavorable phenomenon for users derived from display of old related reservation information is likely to be suppressed. This modification can be embodied by a construction in which the “reservation information” in the above embodiment has been replaced with the “related information.” Incidentally, the order in the ranking and the pattern corresponding to the newness can also be displayed in the program listing PL in the above described embodiment.

Embodiment and modification of the present invention have been exemplified above. However, the embodiment and modification are merely an illustration and should not be construed to limit the scope of the invention. These embodiment and modification can be carried out in other various forms, and various omissions, replacements, combinations, and changes may be made without departing from the subject matter of the invention. These embodiment and modification are included in claims and subject matter and are included in the invention described in claims and equivalents. Further, the present invention can also exert various effects provided by fundamental results (effects) obtained by the constituent element (step). The above effects are an example. The specification of each constituent element may be properly modified. For example, in the embodiment, the elapsed time has been measured. A value alternative to the time (for example, a value obtained by counting the number of retries for the establishment of communication and the number of times of transmission of data for the transmission of data on reservation information) can be used instead of the elapsed time. The present invention is not limited to the embodiments and modification embodiment, and various specifications (for example, shapes, sizes, colors, positions, patterns, and numbers) of various display elements displayed on the display screen (for example, letters, figures, logos, marks, lines, and frames) can be changed according to newness (oldness) of the reservation information(related information).

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method comprising:
obtaining data of a first program and data of a second program through a communication network;
obtaining, though a communication network, first reservation information of the first program and second reservation information of the second program in an electronic device; and
outputting data of a program listing containing the data of the first program, the data of the second program, the first reservation information, and the second reservation information for displaying, wherein
in the data of the program listing, if a period elapsed since a timing of obtaining the first reservation information is different from a period elapsed since a timing of obtaining the second reservation information, a display mode of the data of the first program differs from a display mode of the data of the second program, or a display mode of the first reservation information differs from a display mode of the second reservation information.

2. The method of claim 1, wherein the determination of whether the period elapsed since the timing of obtaining the first reservation information is different from the period elapsed since the timing of obtaining the second reservation information is determination of newness of the first reservation information or the second reservation information.

3. The method of claim 2, further comprising transmitting first data for causing the electronic device to transmit latest reservation information corresponding to the data of the first program or latest reservation information corresponding to the data of the second program.

4. The method of claim 3, wherein the transmission of the first data is performed when the elapsed time of the first reservation information or the second reservation information is greater than a threshold value.

5. The method of claim 3, further comprising making an attempt to establish communication with the electronic device through the communication network, wherein
the transmission of the first data is performed when a response from the electronic device corresponding to the attempt to establish communication with the electronic device has been obtained.

6. The method of claim 2, further comprising acquiring, through the communication network, data on a reference time that is a reference of newness of the first reservation information or the second reservation information.

7. A device comprising:
processing circuitory to obtain data of a first program and data of a second program through a communication network, obtains, through the communication network, first related information of the first program and second related information of the second program in an electronic device, and outputs display data containing the data of the first program, the data of the second program, the first related information, and the second related information for displaying, wherein,
in the display data, if a period elapsed since a timing of obtaining the first reservation information is different from a period elapsed since a timing of obtaining the second reservation information, a display mode of the data of the first program differs from a display mode of the data of the second program, or a display mode of the first related information differs from a display mode of the second related information.

8. The device of claim 7, wherein the processing circuitory further makes an attempt to establish communication with the electronic device through the communication network, and acquires the related information when a response is obtained from the electronic device.

9. The device of claim 7, wherein the processing circuitory further acquires data corresponding to the period elapsed since the timing of obtaining the first reservation information and the period elapsed since the timing of obtaining the second reservation information through the communication network.

10. A computer program product having a non-transitory computer readable medium including programmed instructions, wherein the instructions, when executed by a computer, cause the computer to perform:
obtaining data of a first program and data of a second program through a communication network;
obtaining, through the communication network, first reservation information of the first program and second reservation information of the second program in the electronic device; and
outputting data of a program listing containing the data of the first program, the data of the second program, the first reservation information, and the second reservation information for displaying, wherein,
if a period elapsed since a timing of obtaining the first reservation information is different from a period elapsed since a timing of obtaining the second reservation information, a display mode of the data of the first program differs from a display mode of the data of the second program or a display mode of the first reservation information differs from a display mode of the second reservation information.
